(19) United States
(12) Patent Application Publication
(10) Pub. No.: US 2018/0113591 A1
(43) Pub. Date: Apr. 26, 2018

(54) METHOD FOR REALIZING FUNCTION ADJUSTMENT BY USING A VIRTUAL FRAME REGION AND MOBILE TERMINAL THEREOF

(71) Applicant: NUBIA TECHNOLOGY CO., LTD., Shenzhen (CN)

(72) Inventors: Xiaoxiang CHEN, Shenzhen (CN); Yingchao MA, Shenzhen (CN)

(21) Appl. No.: 15/567,569

(22) PCT Filed: Apr. 20, 2016
(86) PCT No.: PCT/CN2016/079794

§ 371 Date: Oct. 18, 2017

(30) Foreign Application Priority Data
Apr. 23, 2015 (CN) 201510197042.3

(51) Int. Cl. G06F 3/0488

(52) U.S. Cl. CPC G06F 3/0488; H04W 88/02

(57) ABSTRACT

The present disclosure provides a method of realizing function adjustment by using a virtual frame region and a mobile terminal thereof, the method comprises: sensing a touch event concurrently with a contact, and determining whether the touch event belongs to a sliding event; when the touch event belongs to the sliding event, further determining a direction attribute and a location of the sliding event; when the sliding event occurs in the first virtual frame region, switching a function item currently displayed in the first virtual frame region according to the direction attribute; and when the sliding event occurs in the second virtual frame region, adjusting the function parameters of the current function item according to the direction attribute. In the present disclosure, the left side section and right side section of the virtual frame region are set as a function switching region and a function parameter adjusting region, respectively. User experience can be greatly enhanced.

### FIELD OF THE DISCLOSURE

The present disclosure generally relates to the field of communication technology and, more particularly, relates to a mobile terminal and a method for realizing function adjustment by using a virtual frame region.

### BACKGROUND

With the expansion of the built-in memory capacity and the increasingly powerful operation of the terminal devices, such as mobile phones, personal digital assistants (PDAs), and other devices, the number of applications that can be developed and installed in the terminal devices has kept increasing, and the function of applications become increasingly rich. Although the terminal device has become a powerful data processing tool, because of the need to deal with too much data and too many functions, there are still a lot of troubles for the user. Taking the image-effect processing as an example, a user needs to choose a lot of filter effects in order to achieve the desired results, so the entire operation process is very complex. Taking camera operation as another example, sometimes it is difficult to quickly find the function item to adjust, and it is also very difficult to switch between the different functions. Therefore, although the function of the current terminal device meets the needs of many users, from the perspective of user experience, there is no convenient interaction mode available that can provide users fast operation experience.

### BRIEF SUMMARY OF THE DISCLOSURE

The main objective of the present disclosure is to provide a method for realizing function adjustment by using a virtual frame region and a mobile terminal thereof, so as to solve the cumbersome and inconvenience issues of the functional operation procedures in the conventional methods.

In order to achieve the above objective, the embodiments of the present disclosure provide a method of realizing function adjustment using a virtual frame region, wherein, the virtual frame region includes a first virtual frame region and a second virtual frame region, the method of realizing function adjustment using the virtual frame region comprises:

sensing a touch event concurrently with a contact, and determining whether the touch event belongs to a sliding event;

when the touch event belongs to the sliding event, further determining a direction attribute and a location of the sliding event;

when the sliding event occurs in the first virtual frame region, switching a function item currently displayed in the first virtual frame region according to the direction attribute; and

when the sliding event occurs in the second virtual frame region, adjusting the function parameters of the current function item according to the direction attribute.

Determining whether the touch event belongs to the sliding event comprises:

calculating a moving distance of the contact based on an initial coordinate position and a current coordinate position of the contact;

when the moving distance exceeds a pre-set threshold value, determining that the touch event belongs to the sliding event; and

otherwise, determining that the touch event does not belong to the sliding event.

Determining the direction attribute of the sliding event comprises:

determining the direction attribute of the sliding event by comparing coordinate values in a vertical direction of the initial coordinate position and the current coordinate position of the contact.

Determining the region where the sliding event occurs comprises:

when an X-coordinate of the contact of the sliding event [currentX] satisfies 0<currentX<CW1, determining that the sliding event occurs in the first virtual frame region located on a left edge of a touch screen;

when the X-coordinate of the contact [currentX] satisfies (W−CW2)<currentX<W, determining that the sliding event occurs in the second virtual frame region located on a right edge of the touch screen; and

wherein, W is a width of the touch screen, CW1 is a width of the first virtual frame region, and CW2 is a width of the second virtual frame region.

The method further comprises:

dividing a touchable region of the touch screen of a mobile terminal into the first virtual frame region and the second virtual frame region.

The first virtual frame region locates on edge of one side or both sides of the touch screen, and the second virtual frame region is the remaining touchable operation region on the touch screen other than the first virtual frame region.

When the first virtual frame region is divided on the edge of both sides of the touchable operation region of the touch screen, different corresponding special processing modes for touch events are set for the two first virtual frame regions located on the left and right sides, respectively.

The method further comprises dividing the virtual frame region on the touch screen using a fixed dividing mode, including the following step:

defining a location and size of the virtual frame region when a driver is initialized.

The method further comprises dividing the virtual frame region on the touch screen using a free setting mode, including the following steps:

setting a setting interface of the virtual frame region; and

calling the setting interface of the virtual frame region to create or modify number, position, and size of the virtual frame region.

The method further comprises:

after registering two virtual input devices corresponding to the first virtual frame region or the second virtual frame region;

identifying that a current user touch region is the first virtual frame region or the second virtual frame region, according to an identification of the virtual input device; and

determining different processing modes to be executed based on different touch regions.

Accordingly, the present disclosure also provides a mobile terminal with a touch screen, wherein, a first virtual frame region and a second virtual frame region are divided on the touch screen, the mobile terminal comprises:

a bottom report unit, configured to report coordinate position information of a contact in real time, when a touch event concurrently with the contact is sensed;

a slide recognition unit, configured to determine whether the touch event belongs to a sliding event, according to coordinate position information of the contact reported by the bottom layer reporting unit, and when the touch event belongs to the sliding event, further to determine a direction attribute and a location of the sliding event;

a function switching unit, configured to switch a function item currently displayed in the first virtual frame region in accordance with the direction attribute, and to update the adjustment control of corresponding function parameters displayed in the second virtual frame region when the sliding event is determined to occur in the first virtual frame region; and

a parameter adjustment unit, configured to adjust the function parameters of the current function item according to the direction attribute, when the sliding event is determined to occur in the second virtual frame region.

The sliding recognition unit further comprises:

a sliding direction determination module, configured to determine the direction attribute of the sliding event by comparing coordinate values in a vertical direction of the initial coordinate position and the current coordinate position of the contact.

The sliding recognition unit further comprises:

an event region determination module, configured to determine that the sliding event occurs in the first virtual frame region or the second virtual frame region, based on coordinate values in a horizontal direction of the contact, as well as the position and size information of the first virtual frame region and the second virtual frame region.

The mobile terminal further comprises:

a virtual frame region fixed dividing unit, configured to divide a touchable region of the touch screen of the mobile terminal into the first virtual frame region and the second virtual frame region.

the first virtual frame region locates on edge of one side or both sides of the touch screen, and the second virtual frame region is the remaining touchable operation region on the touch screen other than the first virtual frame region.

a virtual frame region fixed dividing unit, configured to set different corresponding special processing modes for touch events for the two first virtual frame regions located on the left and right sides, respectively, when the first virtual frame region is divided on the edge of both sides of the touchable operation region of the touch screen.

the virtual frame region is divided on the touch screen using a fixed dividing mode and a location and size of the virtual frame region are defined when a driver is initialized.

The mobile terminal further comprises:

a setting interface of the virtual frame region, configured to create and modify number, location, and size of the virtual frame regions.

a virtual frame region fixed dividing unit, configured to register two virtual input devices corresponding to the first virtual frame region or the second virtual frame region;

a sliding identification unit, configured to identify that a current user touch region is the first virtual frame region or the second virtual frame region, based on an identification of the virtual input device; and

a parameter adjustment unit, configured to determine different processing modes to be executed based on different touch regions.

In the present disclosure, the left side section and right side section of the virtual frame region are set as a function switching region and a function parameter adjusting region, respectively. It is possible to switch the currently adjustable function item by sliding in the function switching region and adjust the parameter values of the current function item by sliding in the function parameter adjustment region. Greatly facilitate the user by quickly finding the function items that are needed to adjust and quickly adjusting the specific parameter values. The operating procedures can be simplified and the user experience can be greatly enhanced.

### BRIEF DESCRIPTION OF THE DRAWINGS

FIG. 1 is a schematic diagram of a hardware structure of a mobile terminal according to various disclosed embodiments of the present disclosure;

FIG. 2 is a schematic diagram of a wireless communication system of a mobile terminal in the embodiment of FIG. 1;

FIG. 3 is a schematic diagram of a dividing mode of a touch screen for a conventional mobile terminal;

FIG. 4 is a flow chart of a touch operation method of a mobile terminal according to embodiments of the present disclosure;

FIG. 5 is a schematic diagram of dividing a C-zone by a fixed mode according to embodiments of the present disclosure;

FIG. 6 is another schematic diagram of dividing a C-zone by a fixed mode according to embodiments of the present disclosure;

FIG. 7 is a schematic diagram of dividing a C-zone by a free setting mode according to embodiments of the present disclosure;

FIG. 8 is a schematic diagram of a display of a touch screen on a system desktop according to embodiments of the present disclosure;

FIG. 9 is a schematic diagram of a display of a touch screen in a camera application scenario according to embodiments of the present disclosure;

FIG. 10 is a block diagram of a C-zone event processing system according to embodiments of the present disclosure;

FIG. 11 is a flow chart of a C-zone sliding recognition method according to embodiments of the present disclosure;

FIG. 12 is a schematic diagram of a C-zone contact movement according to embodiments of the present disclosure;

FIG. 13 is a flow chart of a touch event recognition method in different virtual frame regions according to embodiments of the present disclosure;

FIG. 14 is a schematic diagram of the dimensions of the C-zone and A-zone according to embodiments of the present disclosure;

FIG. 15 is a flow chart of a method for implementing functional adjustment using a virtual frame region according to embodiments of the present disclosure; and

FIG. 16 is a schematic diagram of a configuration of a mobile terminal according to embodiments of the present disclosure.

Reference will now be made in detail to exemplary embodiments of the disclosure, which are illustrated in the accompanying drawings.

### DETAILED DESCRIPTION

The embodiments disclosed herein are exemplary only and are not intended to limit the scope of the present disclosure.

The various embodiments of a mobile terminal in the present disclosure are described with reference to the accompanying drawings. In the subsequent description, suffixes such as “module”, “part”, or “unit” used for referring to elements is given merely to facilitate explanation of the present disclosure, without having any significant meaning by itself. Accordingly, the “module” and “part” may be mixedly used.

Mobile terminals may be implemented in various forms. For example, the terminal described in the present disclosure may include mobile terminals, such as mobile phones, smartphones, notebook computers, digital broadcast receivers, PDAs (Personal Digital Assistants), PADs (Tablet Computers), PMPs (Portable Multimedia Players), navigation devices, and the like, and fixed terminals such as digital TVs, desktop computers, and the like. Hereinafter, it is assumed that the terminal is a mobile terminal. However, it would be understood by a person in the art that the configuration according to the embodiments of the present disclosure can be also applicable to the fixed types of terminals, except for any elements especially configured for a mobile purpose.

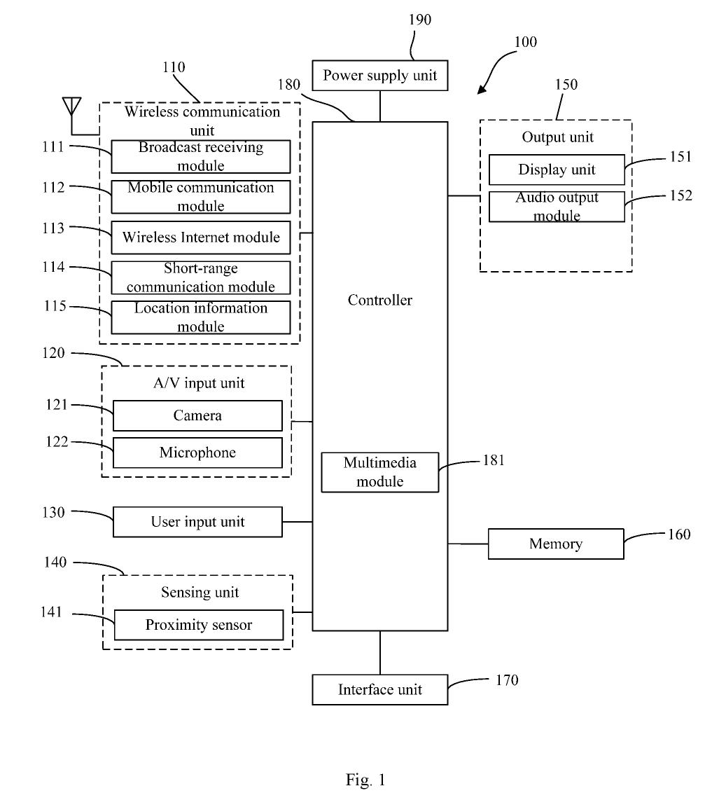

FIG. 1 is a schematic diagram of a hardware structure of a mobile terminal according to various disclosed embodiments of the present disclosure.

The mobile terminal 100 may include a wireless communication unit 110, an A/V (audio/video) input unit 120, a user input unit 130, a sensing unit 140, an output unit 150, a memory 160, an interface unit 170, a controller 180, a power supply unit 190, and the like. FIG. 1 shows the mobile terminal as having various components, but it should be understood that implementing all of the illustrated components is not a requirement. More or fewer components may optionally be implemented. The components of the mobile terminal will be described in detail below.

The wireless communication unit 110 typically includes one or more components allowing radio communication between the mobile terminal 100 and a wireless communication system or a network. For example, the wireless communication unit may include at least one of a broadcast receiving module 111, a mobile communication module 112, a wireless internet module 113, a short-range communication module 114, and a location information module 115.

The broadcast receiving module 111 receives broadcast signals and/or broadcast-associated information from an external broadcast management server via a broadcast channel. The broadcast channel may include a satellite channel and/or a terrestrial channel. The broadcast management server may be a server that generates and transmits a broadcast signal and/or broadcast-associated information or a server that receives a previously generated broadcast signal and/or broadcast-associated information and transmits the same to the terminal. The broadcast signal may include a TV broadcast signal, a radio broadcast signal, a data broadcast signal, and the like. Also, the broadcast signal may further include a broadcast signal combined with a TV or radio broadcast signal. The broadcast-associated information may also be provided via a mobile communication network and, in this instance, the broadcast-associated information may be received by the mobile communication module 112. The broadcast signal may exist in various forms. For example, it may exist in the form of an electronic program guide (EPG) of digital multimedia broadcasting (DMB), an electronic service guide (ESG) of digital video broadcast-handheld (DVB-H), and the like. The broadcast receiving module 111 may be configured to receive broadcast signals by using various types of broadcast systems. In particular, the broadcast receiving module 111 may be configured to receive a digital broadcast signal by using a digital broadcasting system such as digital multimedia broadcast-terrestrial (DMB-T), digital multimedia broadcasting-satellite (DMB-S), digital video broadcast-handheld (DVB-H), the data broadcasting system known as media forward link only (MediaFLO@), integrated services digital broadcast-terrestrial (ISDB-T), and the like. The broadcast receiving module 111 may be configured to be suitable for every broadcast system that provides a broadcast signal as well as the above-mentioned digital broadcast system. Broadcast signals and/or broadcast-associated information received via the broadcast receiving module 111 may be stored in the memory 160 (or another type of storage medium).

The mobile communication module 112 transmits and/or receives radio signals to and/or from at least one of a base station (e.g., access point, Node B, etc.), an external terminal, and a server. Such radio signals may include a voice call signal, a video call signal, or various types of data according to text and/or multimedia message transmission and/or reception.

The wireless internet module 113 supports wireless Internet access of the mobile terminal. The module may be internally or externally coupled to the terminal. The wireless Internet access technique to which the module relates may include a WLAN (Wireless LAN) (Wi-Fi), Wibro (wireless broadband), Wimax (Worldwide Interoperability for Microwave Access), HSDPA (High-Speed Downlink Packet Access), and the like.

The short-range communication module 114 is a module for supporting short-range communications. Some examples of short-range communication technology include Bluetooth™, Radio Frequency Identification (RFID), Infrared Data Association (IrDA), Ultra-Wideband (UWB), Purple Bee™, and the like.

The location information module 115 is a module for checking or acquiring a location (or position) of the mobile terminal. A typical example of the location information module is a GPS (Global Positioning System). According to the current technology, the GPS module 115 calculates distance information from three or more satellites and accurate time information and applies trigonometry to the calculated information to thereby accurately calculate the three-dimensional current location information according to latitude, longitude, and altitude. Currently, a method of calculating location and time information by using three satellites and correcting an error of the calculated location and time information by using another one satellite. In addition, the GPS module 115 can calculate speed information by continuously calculating the current location information in real time.

The A/V input unit 120 is configured to receive an audio or video signal. The A/V input unit 120 may include a camera 121 and a microphone 1220. The camera 121 processes image data of still pictures or video obtained by the image capturing device in an image capturing mode or a video capturing mode. The processed image frame may be displayed on a display unit 151. The image frame processed by the camera 121 may be stored in a memory 160 (or other storage medium) or transmitted via the wireless communication unit 110. Two or more cameras 1210 may be provided according to the configuration of the mobile terminal. The microphone 122 may receive sounds (audible data) via a microphone in a phone call mode, a recording mode, a voice recognition mode, and the like, and can process such a sound into audio data. The processed audio (voice) data may be converted for output into a format transmittable to a mobile communication base station via the mobile communication module 112 during the phone call mode. The microphone 122 may implement various types of noise cancellation (or suppression) algorithms to eliminate (or suppress) noise or interference generated in the course of receiving and transmitting audio signals.

The user input unit 130 may generate key input data from commands entered by a user to control various operations of the mobile terminal. The user input unit 130 allows the user to input various types of information, and may include a keyboard, a dome switch, a touch pad (e.g., a touch sensitive assembly that detects changes in resistance, pressure, capacitance, etc. due to being contacted), a jog wheel, a jog switch, and the like. In particular, when the touch pad is overlaid on the display unit 151 in a layered manner, it may form a touch screen.

The sensing unit 140 detects a current status of the mobile terminal 100 (such as an opened or closed state of the mobile terminal 100), a location of the mobile terminal 100, the presence or absence of the user's contact with the mobile terminal 100 (i.e., the touch input), the orientation of the mobile terminal 100, an acceleration or deceleration movement and direction of the mobile terminal 100, and the like, and generates a command or signal for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled to the external device. The sensing unit 140 may include a proximity sensor 1410. This will be described in relation to a touch screen later.

The interface unit 170 serves as an interface by which at least one external device may be connected to the mobile terminal 100. For example, the external devices may include wired or wireless headset ports, external power supply (or a battery charger) ports, wired or wireless data ports, memory card ports, ports for connecting a device having an identification module, audio input/output (I/O) ports, video I/O ports, earphone ports, or the like. The identification module may be a memory chip that stores various information for authenticating a user for using the mobile terminal 100 and may include a user identity module (UIM), a subscriber identity module (SIM), a universal subscriber identity module (USIM), and the like. In addition, a device having an identification module (referred to as the “identifying device”, hereinafter) may take the form of a smart card. Accordingly, the identifying device may be connected with the mobile terminal 100 via a port or other connection means. The interface unit 170 may be used to receive inputs (e.g., data, information, power, etc.) from an external device and transfer the received inputs to one or more elements within the mobile terminal 100 or may be used to transfer data between the mobile terminal and an external device.

In addition, when the mobile terminal 100 is connected with the external cradle, the interface unit 170 may serve as a conduit to allow power from the cradle to be supplied therethrough to the mobile terminal 100 or may serve as a conduit to allow various command signals input from the cradle to be transferred to the mobile terminal therethrough. Various command signals or power input from the cradle may be operated as a signal for recognizing that the mobile terminal is accurately mounted on the cradle. The output unit 150 is configured to provide outputs in a visual, audible, and/or tactile manner (e.g., audio signal, video signal, alarm signal, vibration signal, etc.). The output unit 150 may include a display unit 151, an audio output module 152, an alarm unit 153, and the like.

The display unit 151 may display information processed in the mobile terminal 100. For example, when the mobile terminal 100 is in a phone call mode, the display unit 151 may display a User Interface (UI) or a Graphical User Interface (GUI) associated with a call or other communication (such as text messaging, multimedia file download, etc.). When the mobile terminal 100 is in a video call mode or image capturing mode, the display unit 151 may display a captured image and/or received image, a UI or GUI that shows videos or images and functions related thereto, and the like.

Meanwhile, when the display unit 151 and the touch pad are overlaid in a layered manner to form a touch screen, the display unit 151 may function as both an input device and an output device. The display unit 151 may include at least one of a Liquid Crystal Display (LCD), a Thin-Film Transistor LCD (TFT-LCD), an Organic Light Emitting Diode (OLED) display, a flexible display, a three-dimensional (3D) display, or the like. Some of them may be configured to be transparent to allow viewing of the exterior, which may be called transparent displays. A typical transparent display may be, for example, a TOLED (Transparent Organic Light Emitting Diode) display, or the like. The mobile terminal 100 may include two or more display units (or other display means) according to its particularly desired embodiment. For example, the mobile terminal may include both an external display unit (not shown) and an internal display unit (not shown). The touch screen can be configured to detect even a touch input pressure as well as a touch input position and a touch input area.

The audio output module 152 may convert, and output as sound, audio data received by the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal receiving sound, a message receiving sound, etc.). The audio output module 152 may include a speaker, a buzzer, or the like.

The alarm unit 153 may provide outputs to inform about the occurrence of an event of the mobile terminal 100. Typical events may include call reception, message reception, key signal input, touch input, and the like. In addition to audio or video outputs, the alarm unit 153 may provide outputs in a different manner to inform about the occurrence of an event. For example, the alarm unit 153 may provide an output in the form of vibrations. When a call, a message, or some other incoming communication is received, the alarm unit 153 may provide tactile outputs (i.e., vibrations) to notify the user thereof. By providing such tactile outputs, the user can recognize the occurrence of various events even if the user's mobile phone is in the user's pocket. Outputs informing about the occurrence of an event may be also provided via the display unit 151 or the audio output module 152 by the alarm unit 153.

The memory 160 may store software programs or the like used for the processing and controlling operations performed by the controller 180, or may temporarily store data (e.g., phone books, messages, still images, video, etc.) that have been output or which are to be output. Also, the memory 160 may store data regarding various patterns of vibrations and audio signals output when a touch is applied to the touch screen.

The memory 160 may include at least one type of storage medium including a Flash memory, a hard disk, a multimedia card, a card type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like. Also, the mobile terminal 100 may cooperate with a network storage device that performs a storage function of the memory 160 over a network connection.

The controller 180 typically controls the general operations of the mobile terminal. For example, the controller 180 performs controlling and processing associated with voice calls, data communications, video calls, and the like. In addition, the controller 180 may include a multimedia module 1810 for reproducing (or playing back) the multimedia data. The multimedia module 1810 may be configured within the controller 180 or may be configured to be separated from the controller 180. The controller 180 may perform a pattern recognition processing to recognize a handwriting input or a picture drawing input performed on a touchscreen as characters or images.

The power supply unit 190 receives external power or internal power and supplies appropriate power required for operating respective elements and components under the control of the controller 180.

Various embodiments as described herein may be implemented in a computer-readable medium using, for example, computer software, hardware, or any combination thereof. For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some instances, such embodiments may be implemented in the controller 180. For software implementation, the embodiments such as procedures or functions may be implemented together with separate software modules that allow performing at least one function or operation. Software codes can be implemented by a software application (or program) written in any suitable programming language, which may be stored in the memory 160 and executed by the controller 180.

So far, the mobile terminal has been described from the perspective of its functions. Hereinafter, a slide-type mobile terminal, among various types of mobile terminal such as folder-type, bar-type, swing-type, slide type mobile terminals, or the like, will be described as an example for the sake of brevity. Thus, the present disclosure can be applicable to any type of mobile terminal, without being limited to a slide-type mobile terminal.

The mobile terminal 100 as shown in FIG. 1 may be configured to operate with a communication system, which transmits data via frames or packets, such as wired and wireless communication systems, as well as satellite-based communication systems.

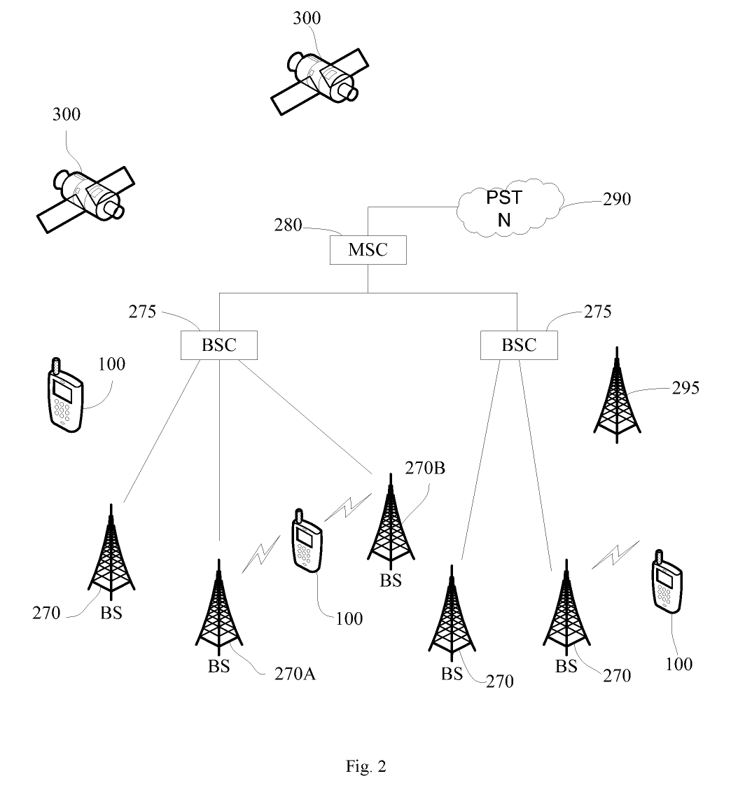

The communication systems in which the mobile terminal according to an embodiment of the present disclosure can operate will now be described with reference to FIG. 2.

Such communication systems may use different air interfaces and/or physical layers. For example, air interfaces utilized by the communication systems include, for example, Frequency Division Multiple Access (FDMA), Time Division Multiple Access (TDMA), Code Division Multiple Access (CDMA), and Universal Mobile Telecommunication Systems (UMTS) [in particular, Long-Term Evolution (LTE)], Global System for Mobile Communications (GSM), and the like. As a non-limiting example, the description hereafter relates to a CDMA communication system, but such teachings equally to other types of systems.

Referring to FIG. 2, a CDMA wireless communication system may include a plurality of mobile terminals 100, a plurality of base stations (BSs) 270, base station controllers (BSCs) 275, and mobile switching centers (MSCs) 280. The MSC 280 is configured to interface with a Public Switched Telephone Network (PSTN). The MSC 280 is also configured to interface with the BSCs 275, which may be coupled to the base station 270 via backhaul lines. The backhaul lines may be configured in accordance with any of several known interfaces including, for example, E1/T1, ATM, IP, PPP, Frame Relay, HDSL, ADSL or xDSL. It is to be understood that the system as shown in FIG. 2 may include a plurality of BSCs 2750.

Each BS 270 may serve one or more sectors (or regions), each sectors covered by an omni-directional antenna or an antenna pointed in a particular direction radially away from the BS 270. Optionally, each sector may be covered by two or more antennas for diversity reception. Each BS 270 may be configured to support a plurality of frequency assignments, and each frequency assignment has a particular spectrum (e.g., 1.25 MHz, 5 MHz, etc.).

The intersection of a sector and frequency assignment may be referred to as a CDMA channel. The BS 270 may also be referred to as base station transceiver subsystems (BTSs) or other equivalent terms. In this situation, the term “base station” may be used to collectively refer to a single BSC 275 and at least one BS 270. The base station may also be referred to as a “cell site”. Optionally, individual sectors of a particular BS 270 may be referred to as a plurality of cell sites.

As shown in FIG. 2, a broadcasting transmitter (BT) 295 transmits a broadcast signal to the mobile terminal 100 operating within the system. The broadcast receiving module 111 shown in FIG. 1 is provided at the mobile terminal 100 to receive the broadcast signals transmitted by the BT 295. Several Global Positioning System (GPS) satellites 300 are shown in FIG. 2. The satellites 300 help locate on least one of the plurality of mobile terminals 100.

A plurality of satellites 300 is depicted in FIG. 2, but it is understood that useful positioning information may be obtained using any number of satellites. The GPS module 115 as shown in FIG. 1 is typically configured to cooperate with the satellite 300 to obtain the desired positioning information. Instead of or in addition to GPS tracking techniques, other technologies that may track the location of the mobile terminals may be used. In addition, at least one of the GPS satellite 300 may selectively or additionally handle satellite DMB transmissions.

As one typical operation of the wireless communication system, the BSs 270 receive reverse-link signals from various mobile terminals 100. The mobile terminals 100 typically engage in calls, messaging, and other types of communications. Each reverse-link signal received by a particular base station 270 is processed within a particular BS 270. The resulting data is forwarded to an associated BSC 275. The BSC provides call resource allocation and mobility management functionality including the coordination of soft handoff procedures between BSs 270. The BSCs 275 also routes the received data to the MSC 280, which provides additional routing services for interfacing with the PSTN 290. Similarly, the PSTN 290 interfaced with the MSC 280, the MSC interfaces with the BSCs 27s, and the BSC 275s in turn control the BSs 270 to transmit forward-link signals to the mobile terminal 100.

Based on the above-mentioned hardware structure of the mobile terminal and communication system, various embodiments of the present disclosure are described below.

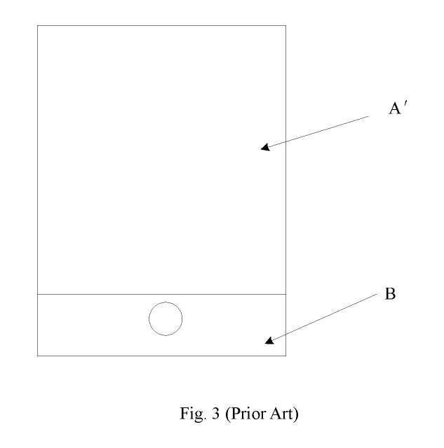

As shown in FIG. 3, the touch screen of the mobile terminal is conventionally divided into a touchable operation region (referred to an A′-zone, hereinafter) and a physical key region (referred to as a B-zone, hereinafter). The A′-zone is the touchable operation region for detecting the coordinates of a touch point, and the B-zone is the physical key region for detecting a menu key, a Home key, a return key, and the like.

According to the conventional touch screen dividing mode, the embodiments of the present disclosure provide a new touch screen dividing mode to realize a new touch operation method, which is particularly suitable for a narrow frame or frameless mobile terminal. First, the A′-zone of the mobile terminal is divided into two regions. One of the regions is within the virtual frame region located on the edge of the screen (referred to as a C-zone, hereinafter), and the other region is the same common region as the conventional method (referred to as an A-zone, hereinafter). A virtual input device is assigned to each region. When the touch event is detected, the region in which the touch event occurs may be determined. When the touch event happens in the C-zone, it is reported by the virtual input device corresponding to the C-zone. When the touch event occurs in the A-zone, it is reported by the virtual input device corresponding to the A-zone. Finally, the mobile terminal performs a special processing on the touch event reported by the virtual input device corresponding to the C-zone, and performs a normal processing on the touch event reported by the virtual input device corresponding to the A-zone as the conventional method.

The special processing of the touch event of the C-zone can be understood as follows. The processing of the touch event of the C-zone is different from the normal processing of the A-zone, such as neglecting, generating effects, function switching, parameter adjustment, or other user-defined processing.

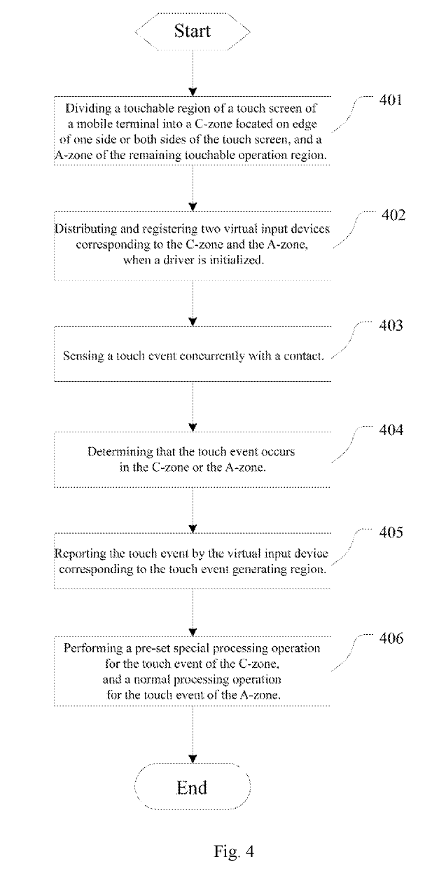

Referring to FIG. 4, a touch operation method of a mobile terminal according to embodiments of the present disclosure includes the followings.

Step 401, a touchable region of the touch screen of the mobile terminal is divided into two regions. The two regions include a first virtual frame region and a second virtual frame region. The first virtual frame region may be located on edge of one side or both sides of the touch screen, i.e., the C-zone, and the second virtual frame region that may be the region of the remaining touchable operation region other than the C-zone on the touch screen, i.e., the A-zone, respectively.

In this step, the C-zone is divided using the following two modes.

The first mode is a fixed mode, in which the location and size (such as width, length, etc.) of the C-zone are set when the driver is initialized. When the C-zone has been set, the A-zone is set to be the remaining touch region on the touch screen.

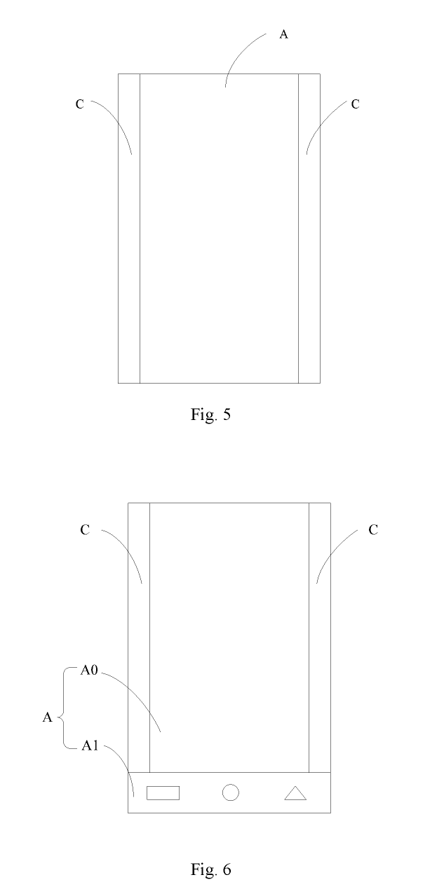

The C-zone setting may be preferably as shown in FIG. 5, and is set on the edge of the touch screen. The width of C-zone is relatively narrow so as not to affect the touch operation of the A-zone.

Optionally, the A-zone includes the A0-zone and the A1-zone as shown in FIG. 6. The A0-zone is an operable region for detecting the coordinates of a touch point, and the A1-zone is a virtual key region for detecting the menu key, the Home key, the return key, and the like. The C-zone is located on the edge of the touch screen and is on both sides of the A-zone. In addition, the C-zone may be set in any other regions that may lead to accidental touch operation.

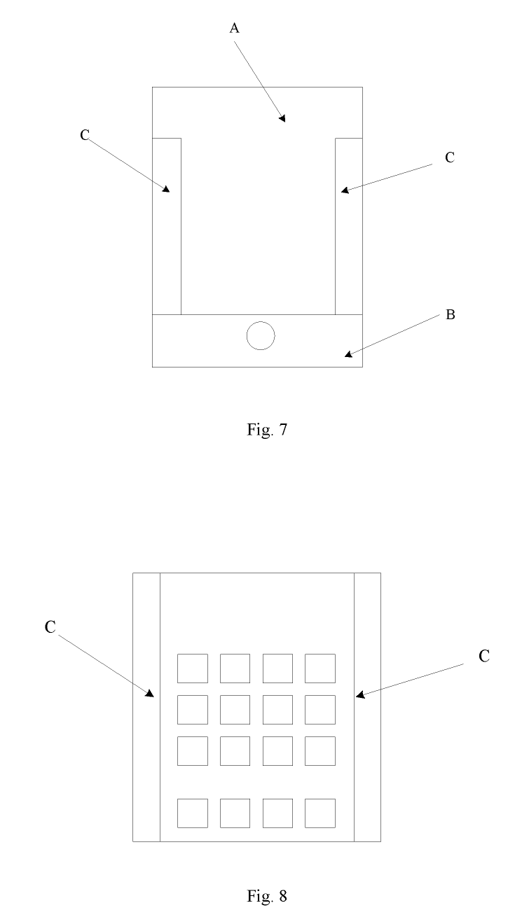

The second mode is a free setting mode, in which a setting interface of the virtual frame region is set in the driver layer. The setting interface of the virtual frame region can be called in the application layer to create or modify the number, location, and size of the virtual frame region. As shown in FIG. 7, in particular, the setting of the width, height, and location of the C-zone can be customized, such as the specific user-defined settings.

Preferably, according to different application scenarios, the present embodiment may further include: calling the setting interface of the virtual frame region to set the number of virtual frame regions, as well as the position and size of each virtual frame regions, respectively. The setting may be creating or modifying, for example, the setting interface of the virtual frame region can be called to respectively create or modify the number, location, and size of the virtual frame region, which is applicable to the current application scenario.

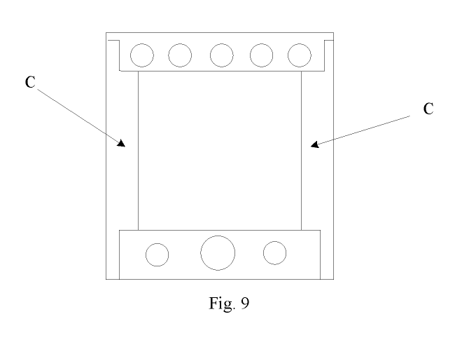

As shown in FIG. 8, since the icon occupies relatively large spaces in the system desktop, the width of both sides of the C-zone is relatively narrow. As shown in FIG. 9, when a user clicks on the camera icon to enter the camera application, the setting interface of the C-zone can be called to set the number, location, and size of the C-zone under this scenario, and the width of the C-zone can be set relatively wide in the case of without affecting the focus.

Step 402, when the touch screen driver is initialized, the two virtual input devices (defined as input0 and input1) are allocated by input_allocate_device( ) and the two input devices are registered by input_register_device( ) where input0 corresponds to the C-zone and input1 corresponds to A-zone.

The method provided by the present embodiment may include: after registering the two virtual input devices corresponding to a first virtual frame region or a second virtual frame region, the upper layer identifying whether a current user touch region is the first virtual frame region or the second virtual frame region, specifically, the C-zone or A-zone, according to an identification of the virtual input device reported by the driver layer; and then determining different processing modes to be executed, based on the different touch regions in the upper layer.

In the present disclosure, the upper layer generally refers to a framework layer, an application layer, and the like. In a mobile terminal system, a custom system such as an Android, an IOS, or the like, typically includes a bottom layer (physical layer, driver layer) and an upper layer (frame layer, application layer). The direction of the signal flow is as follow: the physical layer (touch pad) receiving a user's touch operation; converting a physical pressure into an electrical signal TP; transmitting the TP to the drive layer; analyzing the location of a press by the drive layer; obtaining the specific coordinates of the location, as well as the duration, pressure, and other parameters; uploading the parameters to the framework layer, where the communication between the framework layer and the driver layer can be achieved through the corresponding interface; the framework layer receiving an input device (input) of the driver layer; analyzing the input device; thereby choosing to respond or not respond to the input device; and passing the valid input up to the specific application so as to achieve performing different application operations according different events in the application layer.

Step 403, sensing a touch event concurrently with a contact. The touch event concurrently may be sensed by the mobile terminal via the driver layer.

Step 404, determining the touch event occurred in the C-zone or A-zone.

A touch event is usually an action event such as click, sliding, etc. Each touch event includes one or more contacts, accordingly, the mobile terminal can determine whether the touch event occurs in the C-zone or A-zone by detecting the region where the contact of the touch event falls into.

Specifically, the driver layer of the mobile terminal acquires the coordinates of the contact of the touch event, and determines into which region the coordinates of the contact falls. When the coordinates of the contact fall into the C-zone, it is determined that the touch event occurs in the C-zone. When the coordinates of the contact fall outside the C-zone but into the A-zone, it is determined that the touch event occurs in the A-zone.

Step 405, the touch event is reported by the virtual input device corresponding to the region where the touch event occurs.

When the C-zone senses a touch event concurrently with a contact, the touch event is reported to the upper layer through the virtual input device input0. When the A-zone senses a touch event concurrently with a contact, the touch event is reported to the upper layer through the virtual input device input1.

Step 406, a pre-set special processing operation is performed for the touch event of the C-zone, and a normal processing operation is performed for the touch event of the A-zone.

After receiving the reported events (the reported events including the input device, the touch point parameters, etc.) in the framework layer, firstly, the touch region corresponding to the reported event is recognized, according to an identification of the input device. For example, the driver layer (Kernel) recognizes that the contact occurred in the C-zone in the previous step, accordingly, the driver layer reports to the framework using the input device input1, rather than using input0. That is, the framework layer does not need to determine in which region the current contact occurred, and does not need to determine the size and location of the region either. These determinations are performed in the driver layer. In addition, the driver layer reports not only the specific input device, but also the parameters of the touch point to the framework layer, such as the pressing time, location coordinates, pressure size, and the like.

It should be noted that the framework layer reports to the application layer through a single channel to multi-channel mechanism, after receiving the reported event. Specifically, a channel is firstly registered, through which the reported event is transmitted. The event is listened by the listener, and is then transmitted through different channels to the corresponding application modules for generating different application operations. The application modules include camera, contacts, and other common applications. Further, for producing different application operations, for example, the user's click on the C-zone in the camera application may produce different operations such as focus, shooting, and adjusting the camera parameters. It should be noted that, the reported event is transmitted in a single channel before the reported event is received by the listener, and is then transmitted in the multiple channels after being listened by the listener, while the multiple channels can exist at the same time. The advantage of using the multiple channels is that the events can be transmitted to different application modules at the same time, and different application modules may respond with different application operations.

Optionally, the specified implementation of the above steps is described below.

The object-oriented approach is used to define the categories and implementations of the A-zone and C-zone. After identifying the C-zone, the EventHub function transforms the coordinates of the contact with different resolutions into the coordinates of the LCD, and defines a single-channel function (such as serverchannel, clientchannel, etc.), whose function is to transmit the event through the channel to the event manager (TouchEventManager), when the reported event is received. After being listened by the listener, the event is transmitted to multiple responsive application modules at the same time or one by one via the multiple channels. The event may also be transmitted to only one of the application modules, such as camera, gallery, and the like. Different application modules produce different appropriate operations. The specific implementation of the above steps may also be implemented in other ways, and the embodiments of the present disclosure are not limited thereto.

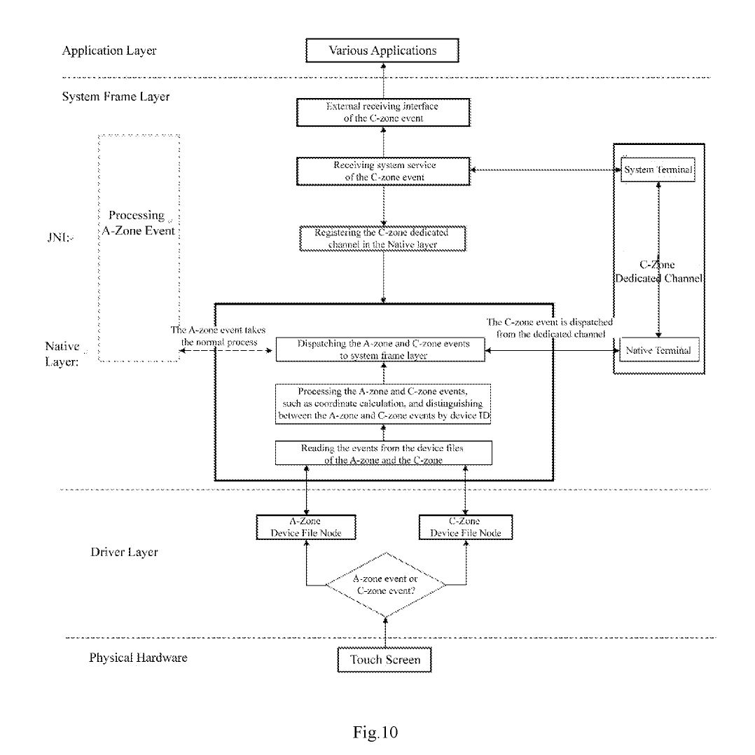

Referring to FIG. 10, the touch operation procedure of the present disclosure will be further described in another manner. The virtual frame region in FIG. 10 is referred to as the C-zone, and the other region is referred to as the A-zone for the sake of simplicity. The reporting process of the touch event is as follows.

The driver layer receives a touch event through a physical hardware such as the touch screen, and determines a touch operation occurred in the A-zone or C-zone, accordingly, reports the event through the A-zone or C-zone device file nodes. A Native layer reads the events from the device files of the A-zone and C-zone, and processes the A-zone and C-zone events, such as coordinate calculation, then distinguishes between the A-zone and C-zone events by device IDs, and finally dispatches the A-zone and C-zone events. The A-zone event is dispatched from the normal channel. That is, the A-zone event is processed according to the normal manner. The C-zone event is dispatched from the C-zone dedicated channel which is pre-registered in the Native layer. The C-zone event is inputted from a Native terminal and is outputted to a system terminal until the end of system service of the C-zone event, and then is reported to various applications through an external interface of the C-zone event.

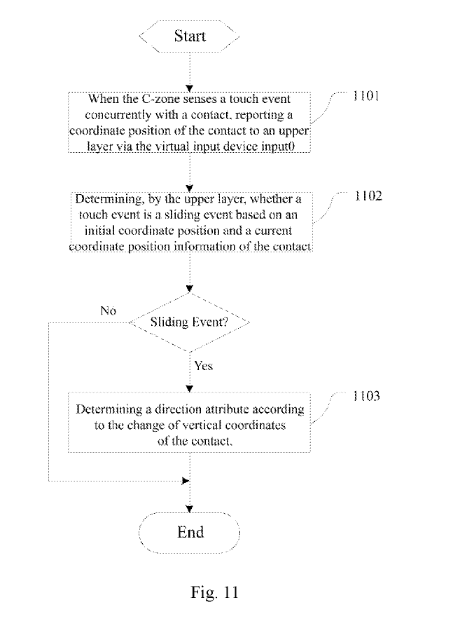

Referring to FIG. 11, according to the touch operation method described in FIG. 4, the present disclosure also provides a C-zone sliding recognition method, comprising the following steps.

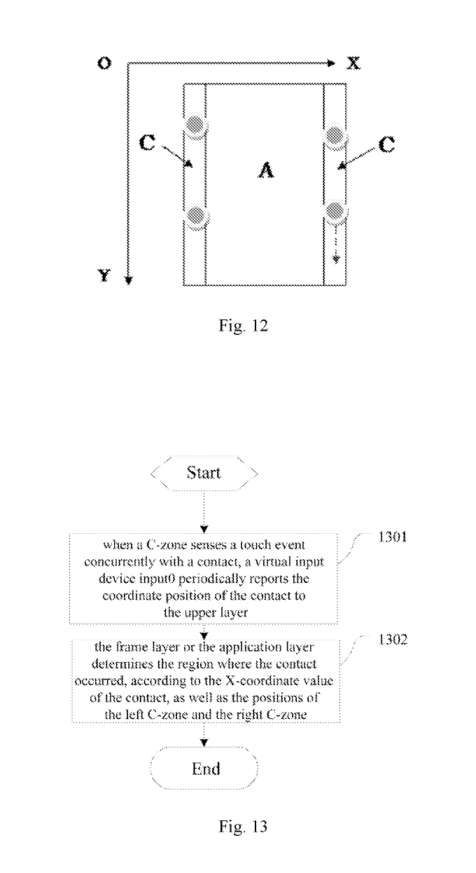

Step 1101, the initial coordinate position of the contact (downX, downY) and the time information of the initial press (downTime) are reported to the upper layer via the virtual input device input0, in the initial moment when the C-zone senses a touch event concurrently with the contact. The current coordinate position (currentX, currentY) of the contact is reported in real time to the upper layer according to a pre-set period during the movement of the contact. The upper layer records the coordinate information as criteria for determining the subsequent sliding. As shown in FIG. 12, the middle part of the touch screen is the A-zone, the narrow edge of the left and right sides are the C-zones, and the gray dot represents the contact in the C-zone.

Step 1102, the upper layer determines whether a touch event is a sliding event based on an initial coordinate position and a current coordinate position information of a contact. If the touch event is a sliding event, proceed to the next step.

Specifically, the report period of the virtual input device input0 can be set to a relatively shorter time value, such as 1/85 sec, so as to achieve more accurate recognition.

In this step, the specific method of determining whether the touch event concurrently with the contact is a sliding event comprises: calculating the moving distance between the current position and the initial position of the contact; determining that the touch event is a sliding event when the moving distance exceeds the pre-set threshold; and otherwise, determining that the touch event is not a sliding event.

The moving distance of the contact is calculated as:

moving distance=\sqrt{(downX−currentX)²+(downY−currentY)²}

Since the C-zone is a virtual frame region, generally, the width of the C-zone is relatively narrow. The decrease of the moving distance in the X-axis direction may be ignored, so that the calculation formula of the moving distance of the contact can be simplified as:

moving distance=|currentY−downY|

Step 1103, the direction attribute of a sliding event can be determined according to the change of coordinate information in a vertical direction of the contact.

In this step, the specific method of determining the sliding direction of the contact comprises: comparing the Y-coordinate values of the current position and the initial position of the contact; determining that the sliding direction of the contact is downward when currentY>downY; and otherwise, determining that the sliding direction is upward.

The direction attribute is not limited to upward or downward, but also may be single reciprocation, multiple reciprocations, or the like. The determination method can be realized according to the change trajectory of the Y-coordinate value of the contact.

As can be seen from the above-described embodiment, the C-zone may be divided only on the edge of one side of the touchable operation region of the touch screen, or separate O-zones may be divided on the edge of both sides.

When the first virtual frame region, i.e., the C-zone, is divided on the edge of both sides of the touchable operation region of the touch screen, different special processing modes may be set for the touch events corresponding to the two first virtual frame regions located on the left and right sides, i.e., the left side C-zone and the right side C-zone, respectively. The operational convenience can be improved. Therefore, it is necessary to identify whether the touch event occurs on the left side C-zone or the right side C-zone.

Referring to FIG. 13, the present disclosure provides a method for identifying the touch events in different virtual frame regions, comprising the steps as follows.

Step 1301, when a C-zone senses a touch event concurrently with a contact, a virtual input device input0 periodically reports the coordinate position (currentX, currentY) of the contact to the upper layer. The upper layer records the coordinate information as the subsequent determination criteria.

Step 1302, the frame layer or the application layer determines the region where the contact occurred, according to the X-coordinate value of the contact, as well as the positions of the left C-zone and the right C-zone.

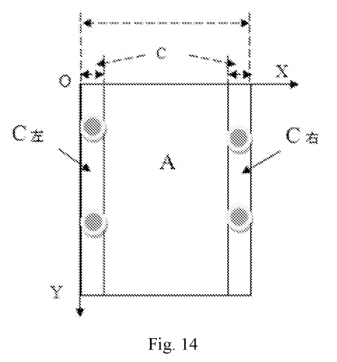

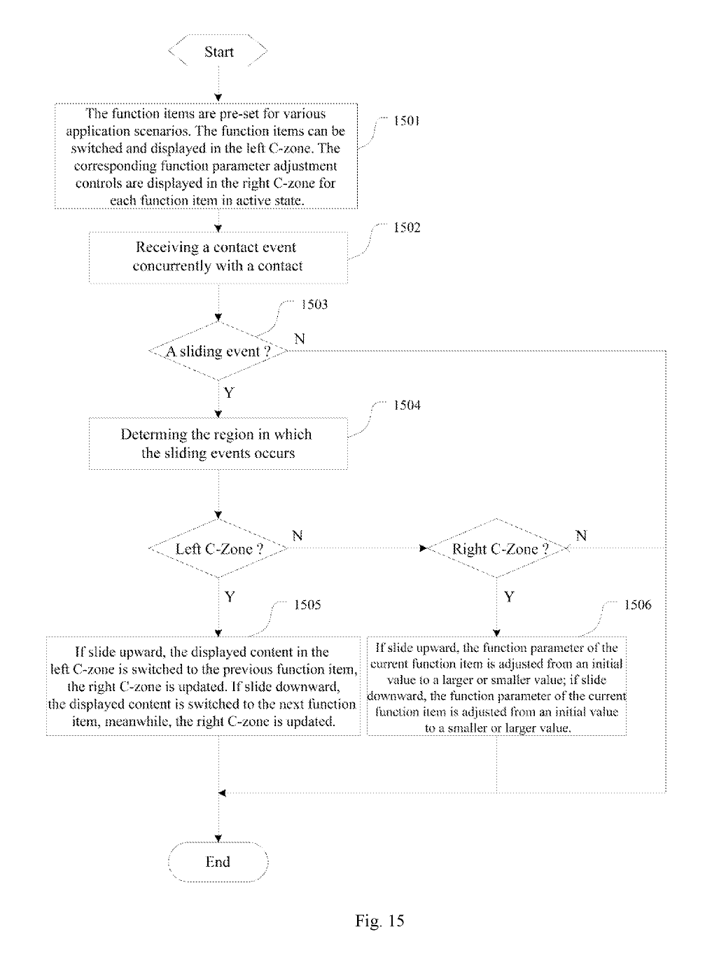

The specific determination mode is as follows. If the X-coordinate of the contact satisfies 0<currentX<CW1, it is determined that the touch event concurrently with the contact occurs in the left C-zone. If the X-coordinate of the contact satisfies (W−CW2)<currentX<W, it is determined that the touch event concurrently with the contact occurs in the right C-zone. As shown in FIG. 14, W is a width of the touch screen, CW1 is a width of the left C-zone, CW2 is a width of the right C-zone. CW1 and CW2 may be the same or may be the different.

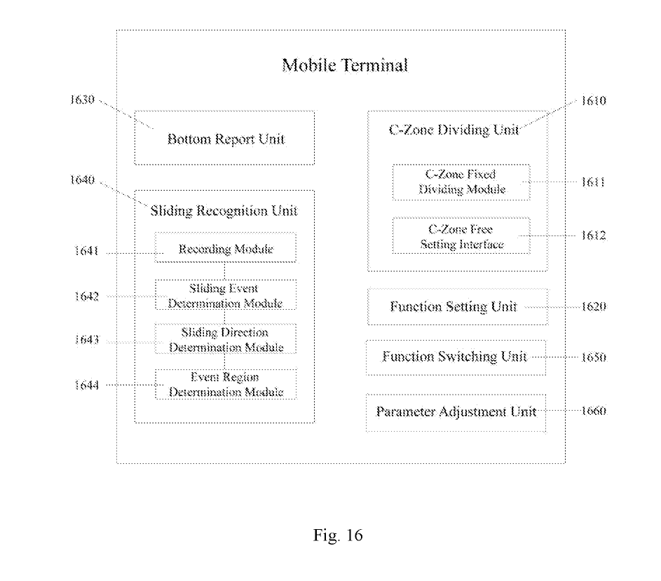

Referring to FIG. 15, a method of implementing a function adjustment by using a virtual frame region according to the present disclosure is applicable to the instance, when the virtual frame regions are divided on both sides of the touch screen (referred to as the left C-zone and the right C-zone for distinguishable description, hereinafter), including the steps as follows.

Step 1501, the left C-zone is set as a function switching region, and the right C-zone is set as a function parameter adjustment region. The function items are pre-set for various application scenarios. The function items which are applicable to the current application scenario can be switched and displayed in the left C-zone. The corresponding function parameter adjustment controls are displayed in the right C-zone for each function item in active state.

In this step, various function items which are applicable to the current application scenario can be switched and displayed in the left C-zone. The function item currently displayed in the left C-zone is set to be active, accordingly, the corresponding function parameter adjustment controls are displayed in the right C-zone. Other function items, which are not currently displayed in the left C-zone, are set to be inactive, and the corresponding function parameter adjustment controls are not displayed in the right C-zone.

Step 1502, receiving a contact event concurrently with a contact.

Step 1503, determining whether or not a touch event is a sliding event. If the touch event is a sliding event, the method proceeds to the next step. The specific determination method is shown in FIG. 11.

Step 1504, determining the region where the sliding event occurred. If the sliding event occurred in the left C-zone, the method proceeds to step 1505. If the sliding event occurred in the right C-zone, the method proceeds to step 1506. The specific determination method is shown in FIG. 13.

Step 1505, determining the direction attribute of the sliding event. If the sliding is upward, the current function item is switched to the previous function item in the left C-zone, meanwhile, the corresponding function parameter adjustment control is updated in the right C-zone. If the sliding is downward, the current function item is switched to the next function item in the left C-zone, meanwhile, the corresponding function parameter adjustment control is updated in the right C-zone. After that, the method goes to step 1507.

In this step, the switching of the function items can be realized by sliding in the left C-zone.

Step 1506, determining the direction attribute of the sliding event. If the sliding is upward, the function parameters corresponding to the current function item are adjusted from an initial value to a larger or smaller value. If the sliding is downward, the function parameters corresponding to the current function item are adjusted from an initial value to a smaller or larger value.

When re-entering the application after exiting, the default items are restored to display in the left C-zone and the right C-zone. That is, the function items, which are displayed at the end of the application, are not recorded.

According to the flowchart of the method as shown in FIG. 15, the user may switch various function items in the current application scenario by sliding upward or downward in the left C-zone, so as to select the function item that is needed to be adjusted. The function parameters of the currently selected function item can be adjusted by sliding upward or downward in the right C-zone. The operation is quick and easy. The method will be described below using an example.

For example, the image processing function items in the image processing application scenario may include a zoom processing function, a contrast adjustment function, a blur processing function, a brightness adjustment function, and the like. Accordingly, the method of implementing the image processing functions in the C-zone comprises the follows steps.

1) On a single photo view page, the left C-zone displays a default function item, such as the zoom processing function.

2) When a left-hand press the image, the current picture can be zoomed in by sliding from bottom to top in the right C-zone using a right-hand, and can be zoomed out by sliding from bottom to top.

3) If the function parameters of other function items, such as contrast, ambiguity, or brightness, are needed to be adjusted, the user can slide one or more times in the left C-zone until switching to the function item that requires operation. One function is switched at each sliding. For example, the current zoom function can be switched to the contrast adjustment function, and then to the blurring function item by sliding from bottom to top. The current zoom function can be switched to the brightness adjustment function and other functions by sliding from top to bottom. The setting of loop switching or non-loop switching can be selected in order to meet the usage habit of different users.

4) When a new function item is selected, such as the blurring function item, the image is pressed using one hand, and the ambiguity parameter can be increased by sliding from bottom to top in the right C-zone using another hand, or can be decreased by sliding from top to bottom in the right C-zone.

Accordingly, the present embodiment further provides a mobile terminal as shown in FIG. 16, comprising:

a C-zone dividing unit 1610, configured to divide a left C-zone and a right C-zone on the edge of both sides of a touch screen. Specifically, the unit including a C-zone fixed dividing module 1611, configured to define the location and size of a virtual frame region when the driver is initialized for realizing a fixed dividing mode, and a C-zone setting interface 1612, configured to create and modify the number, location, and size of the virtual frame region, and to be called in the upper layer to achieve a user-defined dividing mode;

a function setting unit 1620, configured to pre-set various function items that can be switched and displayed in the left C-zone for a current application scenario at the time of initialization, and to display the corresponding function parameter adjustment control in the right C-zone for each function item in active state;

a bottom report unit 1630, configured to report coordinate position information of a contact in real time, when a touch event concurrently with the contact is sensed;

a slide recognition unit 1640, configured to determine whether or not the touch event belongs to a sliding event, according to coordinate position information of the contact reported by the bottom layer reporting unit 1630, and if yes, further to determine a direction attribute and a location of the sliding event;

a function switching unit 1650, configured to switch a function item currently displayed in the left C-zone to the previous one or the next one in accordance with the direction attribute, when the sliding event is determined to occur in the left C-zone, and to update the corresponding function parameter adjustment control displayed in the right C-zone; and

a parameter adjustment unit 1660, configured to increase or decrease the current function parameter from an initial value according to the direction attribute, when the sliding event is determined to occur in the left C-zone.

Specifically, the slide recognition unit 1640 includes:

a recording module 1641, configured to record coordinate position information of a contact;

a sliding event determination module 1642, configured to calculate a moving distance of the contact according to the initial coordinate position and the current coordinate position of the contact, and to compare the moving distance with a pre-set threshold to determine whether the touch event belongs to the sliding event or not;

a sliding direction determination module 1643, configured to determine a direction attribute of the sliding event by comparing coordinate values in a vertical direction of the initial coordinate position and the current coordinate position of the contact; and

an event region determination module 1644, configured to determine that the sliding event occurs on a left C-zone or a right C-zone in accordance with coordinate values in a horizontal direction of the contact, as well as the position and the size information of the left C-zone and the right C-zone.

In the above embodiment, only one exemplary application method of the C-zone is described. In practical applications, the user can also use the C-zone to achieve a variety of other functions to enhance the user experience. The examples will be described as below.

If a C-zone in a relatively narrow width is set at only one side of a touch screen, the following applications can be achieved using a unilateral drop-down setting mode.

1) Multi-task switching function. A display interface in an A-zone is switched from a current application interface to a previous application interface by an upward sliding operation in the C-zone. The display interface in the A-zone is switched from a current application interface to a next application interface by a downward sliding operation in the C-zone;

2) Open the specified application function. The corresponding application types are pre-set for different sliding directions. A pre-set corresponding application can be opened, when the C-zone senses the upward/downward sliding event. The user can set up one or two applications with the highest frequency of use in accordance with their own usage habit with this feature. The time-consuming flaws in the conventional approach (looking for specified applications from many applications on the desktop) can be conquered;

3) Return function. The upper layer immediately performs a return operation, when the C-zone senses an upward/downward sliding event. The user does not need to press the physical button at the bottom of the display or the virtual return button on the touch screen with this feature. The ease of operation is greatly increased;

4) Multi-task thumbnail switching function. The thumbnails of various applications that are currently running in the background are displayed in order in the C-zone, when sliding upward and downward in the C-zone. The corresponding application is started when the contact is lifted; and

5) Quick flipping function. The corresponding processing manner of the touch event of the C-zone is defined as flipping. The user can turn the page forward or backward by gently sliding in the C-zone. The majority of readers can be greatly facilitated.

If the C-zones in a relatively narrow width is set at both sides of a touch screen, the following applications can be achieved using a bilateral drop-down setting mode.

1) Brightness adjustment function. The screen brightness can be increased by sliding upward on one side of the C-zone, and can be decreased by sliding downward on another side of the C-zone. The user does not need to adjust the brightness through a physical key or entering into the setting interface;

2) Volume adjustment function. The volume can be increased by sliding upward on one side of the C-zone and can be decreased by sliding downward on another side of the C-zone; and

3) Show hidden content. The hidden contents (such as apps, images, files, texts messages, etc.) can be shown when sliding upward, and the relevant contents can be hidden when sliding downward.

If the C-zone in a relatively narrow width is set at only one side of the touch screen, the following applications can be achieved using a unilateral drop-down setting mode.

Mobile acceleration function. When the number of times sliding up and down reaches a threshold value of twice back and forth, it is initiated. The background applications can be cleaned up to release the memory, and the processing results can be notified to the user at the end of the processing. This is applicable to gamers and the like.

It should be noted that, in this context, the use of terms such as “comprising”, “including”, or any other variant thereof is intended to encompass a non-exclusive inclusion, such that processes, methods, articles, or devices comprising a series of elements includes not only those elements, but also other elements that are not explicitly listed, or are elements that are inherent to such processes, methods, articles, or devices. In the absence of more restrictions, the elements defined by the statement “including a . . . ” do not exclude the presence of additional elements in the processes, methods, articles, or devices that includes the element.

The above-described embodiments of the present disclosure are for the sake of description only and are not representative of the embodiments.

With the description of the above embodiments, it will be apparent to the person in the art that the method according to the above embodiments can be realized by means of software plus the necessary general hardware platform, and can also be realized only by the hardware platform. In many instances, the implementation of the former way is better. Based on this understanding, the technical solution of the present disclosure, in essence, or in the form of a contribution to the prior art, can be embodied in the form of a software product stored in a storage medium (such as ROM/RAM, magnetic disc, optical disc), which may include a number of instructions for enabling a terminal device (which may be a mobile phone, a computer, a server, an air conditioner, or a network device, and the like.) to perform the method described in various embodiments of the present disclosure.

The foregoing is merely a preferred embodiment of the present disclosure and is not intended to limit the scope of the disclosure. Both of which is to be carried out by equivalent structure or equivalent process transformation using the present specification and the accompanying drawings, and directly or indirectly is to be applied in other related technical fields, are included within the scope of the protection of the present disclosure

1. A method of realizing function adjustment using a virtual frame region, wherein the virtual frame region includes a first virtual frame region and a second virtual frame region, the method of realizing function adjustment using the virtual frame region comprising:
sensing a touch event concurrently with a contact, and determining whether the touch event belongs to a sliding event;
when the touch event belongs to the sliding event, further determining a direction attribute and a location of the sliding event;
when the sliding event occurs in the first virtual frame region, switching a function item currently displayed in the first virtual frame region according to the direction attribute; and
when the sliding event occurs in the second virtual frame region, adjusting the function parameters of the current function item according to the direction attribute.

2. The method of realizing function adjustment using the virtual frame region according to claim 1, wherein determining whether the touch event belongs to the sliding event further comprises:
calculating a moving distance of the contact based on an initial coordinate position and a current coordinate position of the contact;
when the moving distance exceeds a pre-set threshold value, determining that the touch event belongs to the sliding event; and
otherwise, determining that the touch event does not belong to the sliding event.

3. The method of realizing function adjustment using the virtual frame region according to claim 1, wherein determining the direction attribute of the sliding event comprises:
determining the direction attribute of the sliding event by comparing coordinate values in a vertical direction of the initial coordinate position and the current coordinate position of the contact.

4. The method of realizing function adjustment using the virtual frame region according to claim 1, wherein determining the region where the sliding event occurs comprises:
when an X-coordinate of the contact of the sliding event [currentX] satisfies 0<currentX<CW1, determining that the sliding event occurs in the first virtual frame region located on a left edge of a touch screen;
when the X-coordinate of the contact [currentX] satisfies (W−CW2)<currentX<W, determining that the sliding event occurs in the second virtual frame region located on a right edge of the touch screen; and
wherein, W is a width of the touch screen, CW1 is a width of the first virtual frame region, and CW2 is a width of the second virtual frame region.

5. The method of realizing function adjustment using the virtual frame region according to claim 1, further comprising:
dividing a touchable region of the touch screen of a mobile terminal into the first virtual frame region and the second virtual frame region.

6. The method of realizing function adjustment using the virtual frame region according to claim 5, wherein,
the first virtual frame region locates on edge of one side or both sides of the touch screen, and the second virtual frame region is the remaining touchable operation region on the touch screen other than the first virtual frame region.

7. The method of realizing function adjustment using the virtual frame region according to claim 6, further comprising:
when the first virtual frame region is divided on the edge of both sides of the touchable operation region of the touch screen, setting different corresponding special processing modes for touch events for the two first virtual frame regions located on the left and right sides, respectively.

8. The method of realizing function adjustment using the virtual frame region according to claim 5, further comprising:
dividing the virtual frame region on the touch screen using a fixed dividing mode; and
defining a location and size of the virtual frame region when a driver is initialized.

9. The method of realizing function adjustment using the virtual frame region according to claim 5, further comprising:
dividing the virtual frame region on the touch screen using a free setting mode;
setting a setting interface of the virtual frame region; and
calling the setting interface of the virtual frame region to create or modify number, position, and size of the virtual frame region.

10. The method of realizing function adjustment using the virtual frame region according to claim 1, further comprising:
after registering two virtual input devices corresponding to the first virtual frame region or the second virtual frame region, identifying that a current user touch region is the first virtual frame region or the second virtual frame region according to an identification of the virtual input device; and
determining different processing modes to be executed, based on different touch regions.

11. A mobile terminal with a touch screen, wherein a virtual frame region is divided on the touch screen, and the virtual frame region includes a first virtual frame region and a second virtual frame region, the mobile terminal comprising:
a bottom report unit, configured to report coordinate position information of a contact in real time, when a touch event concurrently with the contact is sensed;
a slide recognition unit, configured to determine whether the touch event belongs to a sliding event according to coordinate position information of the contact reported by the bottom layer reporting unit, and when the touch event belongs to the sliding event, further to determine a direction attribute and a location of the sliding event;
a function switching unit, configured to switch a function item currently displayed in the first virtual frame region in accordance with the direction attribute, and to update the adjustment control of corresponding function parameters displayed in the second virtual frame region, when the sliding event is determined to occur in the first virtual frame region; and
a parameter adjustment unit, configured to adjust the function parameters of the current function item according to the direction attribute, when the sliding event is determined to occur in the second virtual frame region.

12. The mobile terminal according to claim 11, wherein, the sliding recognition unit further comprises:
a recording module, configured to record coordinate position information of the contact reported by the bottom reporting unit; and
a sliding event determination module, configured to calculate a moving distance of the contact based on an initial coordinate position and a current coordinate position of the contact, and to compare the moving distance with a pre-set threshold for determining whether the touch event belongs to the sliding event.

13. The mobile terminal according to claim 12, wherein, the sliding recognition unit further comprises:
a sliding direction recognition module, configured to determine the direction attribute of the sliding event by comparing coordinate values in a vertical direction of the initial coordinate position and the current coordinate position of the contact.

14. The mobile terminal according to claim 13, wherein the sliding recognition unit further comprises:
an event region determination module, configured to determine that the sliding event occurs in the first virtual frame region or the second virtual frame region, based on the coordinate values in a horizontal direction of the contact, as well as position and size information of the first virtual frame region and the second virtual frame region.

15. The mobile terminal according to claim 11, further comprising:
a virtual frame region fixed dividing unit, configured to divide a touchable region of the touch screen of the mobile terminal into the first virtual frame region and the second virtual frame region.

16. The mobile terminal according to claim 15, wherein,
the first virtual frame region locates on edge of one side or both sides of the touch screen, and the second virtual frame region is the remaining touchable operation region on the touch screen other than the first virtual frame region.

17. The mobile terminal according to claim 16, wherein,
a virtual frame region fixed dividing unit, configured to set different corresponding special processing modes for touch events for the two first virtual frame regions located on the left and right sides, respectively, when the first virtual frame region is divided on the edge of both sides of the touchable operation region of the touch screen.

18. The mobile terminal according to claim 15, wherein, the virtual frame region is divided on the touch screen using a fixed dividing mode, and a location and size of the virtual frame region are defined when a driver is initialized.

19. The mobile terminal according to claim 15, further comprising:
a setting interface of the virtual frame region, configured to create and modify number, location, and size of the virtual frame region.

20. The mobile terminal according to claim 15, wherein,
a virtual frame region fixed dividing unit, configured to register two virtual input devices corresponding to the first virtual frame region or the second virtual frame region;
a sliding identification unit, configured to identify that a current user touch region is the first virtual frame region or the second virtual frame region, based on an identification of the virtual input device; and
a parameter adjustment unit, configured to determine different processing modes to be executed, based on different touch regions.
